(19) United States
(12) Patent Application Publication
(10) Pub. No.: US 2012/0192692 A1
(43) Pub. Date: Aug. 2, 2012

(54) Sheet Material Punching Device

(75) Inventor: Naoki Sugie, Nagoya-shi (JP)

(73) Assignee: RICOH ELEMEX CORPORATION, Nagoya-shi (JP)

(21) Appl. No.: 13/354,393

(22) Filed: Jan. 20, 2012

(30) Foreign Application Priority Data
Jan. 31, 2011 (JP) 2011-017803

(51) Int. Cl. B26F 1/02; B26D 7/01

(52) U.S. Cl. 83/441.1

(57) ABSTRACT

A sheet material punching device comprises punching pins, a die member having die holes formed therein, a frame having a housing space defined by wall portions inside to house therein the die member and the punching pins, the frame having a longitudinal direction extending in a width direction of a sheet material W, and paper feed ports formed in the wall portions of the frame for the sheet material W to be transported through, wherein the die member being bridged across the paper feed ports is supported in a predefined length in the width direction of the sheet material W. The sheet material punching device thus configured can prevent deflection of the die member caused by a punching force applied to the die member by the punching pins during the formation of punched holes.

### RELATED APPLICATIONS

This application claims the priority of Japanese Patent Application No. 2011-017803 filed on Jan. 31, 2011. The disclosure of the prior application is hereby incorporated herein in the entirety by reference.

### BACKGROUND OF THE INVENTION

1. Field of the Invention

This invention relates to a sheet material punching device configured to form punched holes in a sheet material for filing purpose.

2. Description of the Related Art

Conventionally, image formation apparatuses, such as a copying machine and a printer, are additionally equipped with a sheet material punching device configured to form punched holes for filing purpose in a sheet material which is a sheet of paper on which an image is formed. An example of the sheet material punching device is disclosed in Japanese Unexamined Patent Application Publication No. 2000-233396 (Patent Document 1, etc.).

As illustrated in FIG. 14, the sheet material punching device is configured such that a die frame DF having die holes D formed so as to face a lower surface of a punching frame PF including punches P driven in a reciprocating manner is provided on the lower surface of the punching frame PF with an interval S for paper feed therebetween, wherein fastening sections F of the die frame DF at two positions on both end sides thereof in a longitudinal direction are securely fixed to the lower surface by means of screws or rivets. The die frame DF and the punching frame PF thus structured constitute a frame assembly.

### RELATED ART DOCUMENT

### Patent Document

[Patent Document 1] Japanese Unexamined Patent Application Publication No. 2000-233396

### SUMMARY OF THE INVENTION

In an attempt to form punched holes in a thick sheet material or a hard sheet material using such a sheet material punching device, an applied load is maximized when the punches P are punctured into a sheet material W. At this time, a stress (punching reaction force) is generated in the die frame DF having the die holes D, the fastening sections F of the punching frame PF including the punches P for punching holes which form punched holes, and also the whole frames, thereby generating deflection in the respective frames depending on rigidity properties of the frames (FIG. 14 illustrates the deflection of the die frame DF).

Then, a force (energy) to be desirably solely dedicated to the formation of punched holes in the sheet material W escapes to the deflection. This requires extra energy, resulting in a poor efficiency. To ensure rigidity by increasing strength, the punching frame PF is increased in thickness or bent in a U-like shape, or the fastening sections F are made stronger. These measures, however, inevitably increase the punching device per se in weight and size, resulting in a difficulty in producing the punching device inexpensively.

The invention was carried out to solve the above-described problems. The invention provides a sheet material punching device that has an improved structure for supporting a die member by using a frame superior in rigidity. The sheet material punching device is structurally simplified and downsized with less production cost.

To solve the above-described problems, a sheet material punching device according to the invention comprises: a punching pin driven so as to reciprocate on a sheet material being transported; a die member having die holes to form punched holes jointly with the punching pin in the sheet material placed thereon in a thickness direction of the sheet material; a frame having wall portions respectively provided on an upstream side and a downstream side in a transport direction of the sheet material, the die member and the punching pin being provided in a space between the wall portion on the upstream side and the wall portion on the downstream side, the frame further having a longitudinal direction extending in a width direction of the sheet material; and paper feed ports respectively formed in the wall portions on the upstream and downstream sides, the paper feed ports being provided for the sheet material to be transported through, wherein the die member being bridged across between the paper feed ports on the both sides is supported in a predefined length in the width direction of the sheet material.

The structural feature, wherein the die member subject to a punching force applied by the punching pin is directly supported by the frame superior in rigidity, can prevent deformation caused by deflection of the die member during punching. The support structure is provided to bridge across between the upstream and downstream sides in the transport direction of the paper feed ports formed in the frame, and the die member is thereby supported in the predefined length in the width direction of the sheet material. Such a structural feature provides a better strength against the punching force than the conventional die frame DF fastened by securely fixing the fastening sections F at two positions on both end sides thereof, and also reduces any energy loss resulting from deflection.

To solve the above-described problems, the sheet material punching device according to the invention is further configured such that the wall portions of the frame having the paper feed ports on the both sides thereof are side plate portions formed in a plate shape, the side plate portions on the both sides have cutouts formed at given intervals in the thickness direction of the sheet material serving as the paper feed ports, the die member is formed from a band plate member, and the die member is bridged across between the cutouts with one and the other sides in a band width direction thereof being caught on the cutouts.

As a result of the structural feature, the frame and the die member can be provided in simple plate-like shapes, and the whole device can be downsized and reduced in weight with less production cost.

To solve the above-described problems, the sheet material punching device according to the invention is further configured such that the die member has a sheet material transport guide protruding on the upstream side in the transport direction to stay in contact with a transport destination edge side of the transported sheet material to thereby slidably guide the sheet material through the paper feed ports.

According to the structural feature wherein the sheet material can be guided by the sheet material transport guide, the sheet material can be reliably transported to the punching position.

To solve the above-described problems, the sheet material punching device according to the invention is further configured such that the die member has a protruding plate portion protruding in a plate thickness direction thereof, and the protruding plate portion is joined with a side plate portions of the frame.

According to the structural feature, the protruding plate portion can serve as a strength reinforcing member against the punching force applied by the punching pin, leading to a better strength against the deflection of the die member during punching.

To solve the above-described problems, the sheet material punching device according to the invention is further configured such that a plurality of the punching pins are provided, and a plurality of die members each having a die hole are provided to be respectively paired with the punching pins.

The structural feature, wherein the die members can be located only at any intended positions, can achieve further weight reduction and strength improvement.

To solve the above-described problems, a sheet material punching device according to the invention comprises: a punching pin driven so as to reciprocate on a sheet material being transported; a die member having die holes to form punched holes jointly with the punching pin in the sheet material placed thereon in a thickness direction of the sheet material; a frame having wall portions respectively provided on an upstream side and a downstream side in a transport direction of the sheet material, the die member and the punching pin being provided in a space between the wall portion on the upstream side and the wall portion on the downstream side, the frame further having a longitudinal direction extending in a width direction of the sheet material; and paper feed ports respectively formed in side plate portions on both sides of a center plate portion of the die member formed in an H-like shape in cross section and having the die holes in the center plate portion thereof, the feed ports being provided for the sheet material to be transported through and placed on the center plate portion, wherein the side plate portions on the both sides of the die member are joined with the wall portions of the frame so that the die member and the frame are integral with each other.

The structural feature, wherein the die member per se is formed in the H-like shape in cross section by the plate member, can increase a modulus of section, thereby providing better rigidity properties. Such a structural feature provides a better strength against the punching force than the conventional die frame DF fastened by securely fixing the fastening sections F at two positions on both end sides thereof, and also reduces any energy loss resulting from deflection.

### BRIEF DESCRIPTION OF DRAWINGS

FIG. 1 is a perspective view of a sheet material punching device according to the invention.

FIG. 2 is a cross-sectional view cut along A-A illustrated in FIG. 1.

FIG. 3 is a perspective view of a punching pin driving mechanism.

FIG. 4 is a cross-sectional view illustrating a modified embodiment of the sheet material punching device.

FIG. 5 is a cross-sectional view of a first modified embodiment of the illustration in FIG. 4.

FIG. 6 is a cross-sectional view of a second modified embodiment of the illustration in FIG. 4.

FIG. 7 is a cross-sectional view of a third modified embodiment of the illustration in FIG. 4.

FIG. 8 is a cross-sectional view of a fourth modified embodiment of the illustration in FIG. 4.

FIG. 9 is a cross-sectional view illustrating another modified embodiment of the sheet material punching device.

FIG. 10 is a cross-sectional view illustrating still another modified embodiment of the sheet material punching device.

FIG. 11 is a cross-sectional view of a modified embodiment of the illustration in FIG. 10.

FIG. 12 is a perspective view of the illustration in FIG. 11.

FIG. 13 is an illustration of another example of a frame.

FIG. 14 is a cross-sectional view of a conventional sheet material punching device.

### EMBODIMENTS OF THE INVENTION

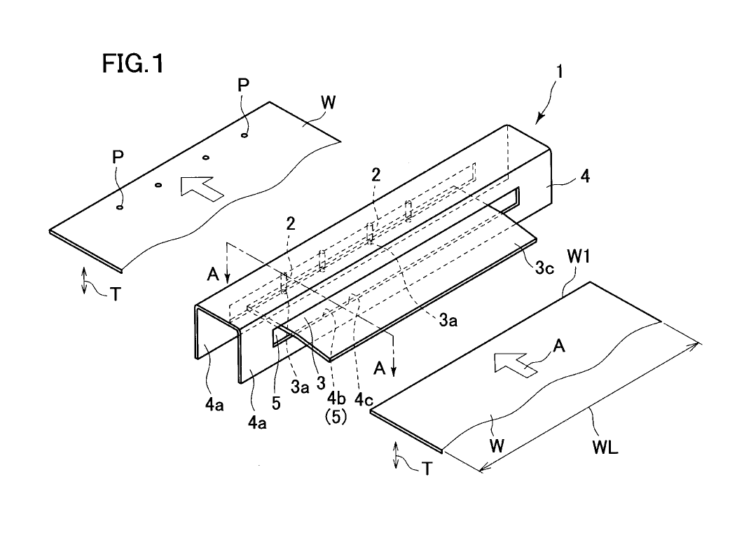

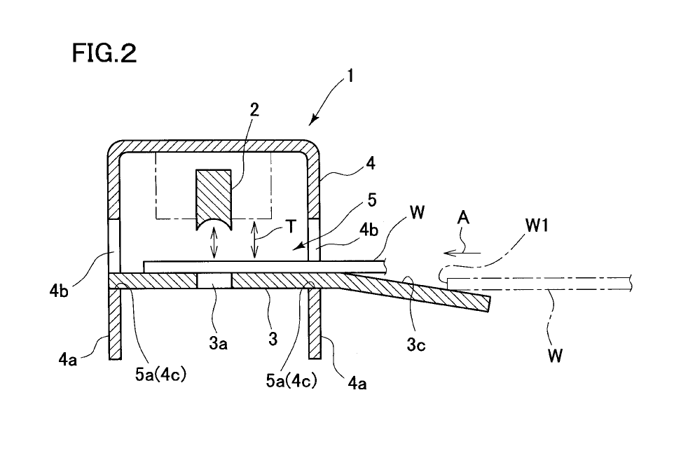

Hereinafter, an embodiment of the invention is described referring to the accompanied drawings. FIG. 1 is a perspective view of a sheet material punching device according to an embodiment of the invention. FIG. 2 is a cross-sectional view cut along A-A illustrated in FIG. 1.

Referring to FIGS. 1 and 2, a sheet material punching device 1 is an apparatus used in an image formation apparatus (not shown) such as a copying machine or a printer. The sheet material punching device 1 is configured to form punched holes P for filing purpose in a sheet material W which is a sheet of paper on which an image is formed.

The sheet material punching device 1 includes punching pins 2 provided so as to face the sheet material W being transported and driven so as to reciprocate on the sheet material W, and a die member 3 having die holes 3a to form punched holes P jointly with the punching pin 2 in the sheet material W placed thereon in a thickness direction T of the sheet material W. The punching pin 2, the die member 3, and a frame 4 having a housing space therein where the punching pin 2 and the die member 3 can be housed constitute an assembly unit.

To confer good rigidity properties against a punching reaction force applied by the punching pins 2 when the punched holes P are formed in the sheet material W, the frame 4 is formed in a laterally long shape having a longitudinal direction extending in a width direction of the sheet material W. The frame 4 can be produced from a sheet metal member having a given thickness that can be selected from members made of synthetic resins, iron, aluminum, stainless steel, and ribbon steel (hardened steel band) depending on the type of the sheet material W. Further, the frame 4 is formed in a beam shape with a U-like cross section to increase a modulus of section for better rigidity, the housing space therein is defined by side plate portions 4a serving as walls. The frame 4 is laterally longer than a width dimension WL of the sheet material W.

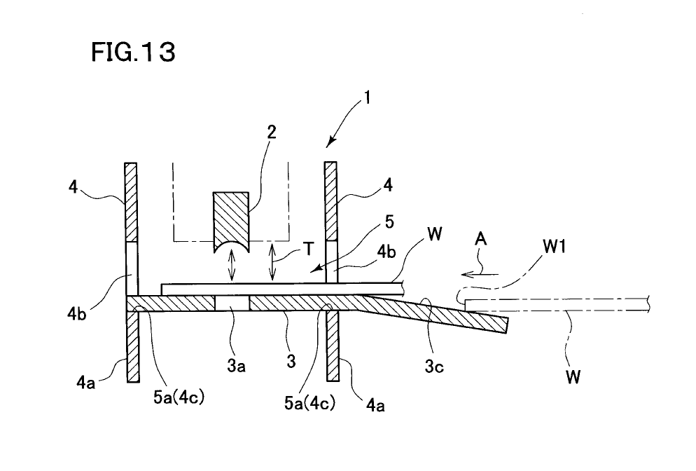

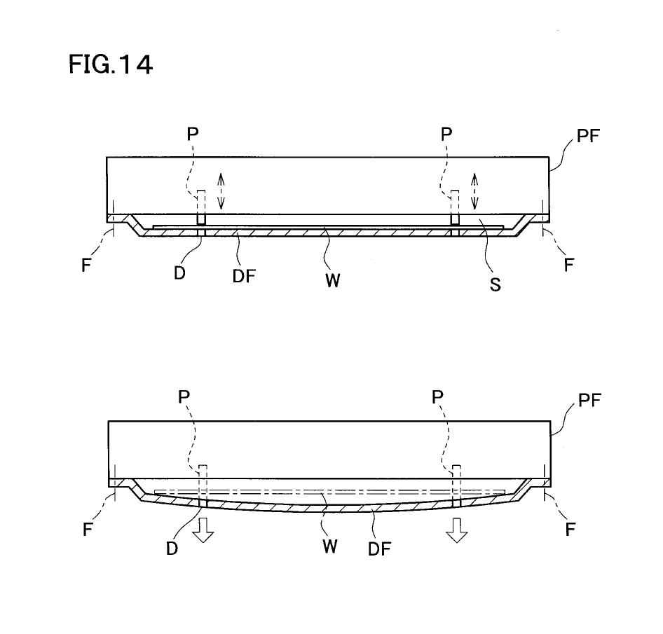

The sectional shape of the frame 4 is not particularly limited as far as the frame 4 has a structural shape that can ensure an enough strength against the punching reaction force applied thereto by the punching pins 2 when the punched holes P are formed in the sheet material W. Examples of such a shape are rectangular cylindrical shape and circular cylindrical shape. As illustrated in FIG. 13, the side plate portions 4a and 4a of the frame 4 according to the invention may be two independent plates. To use two different plates independently provided as the side plate portions 4a and 4a may be applied to all of the embodiments of the invention.

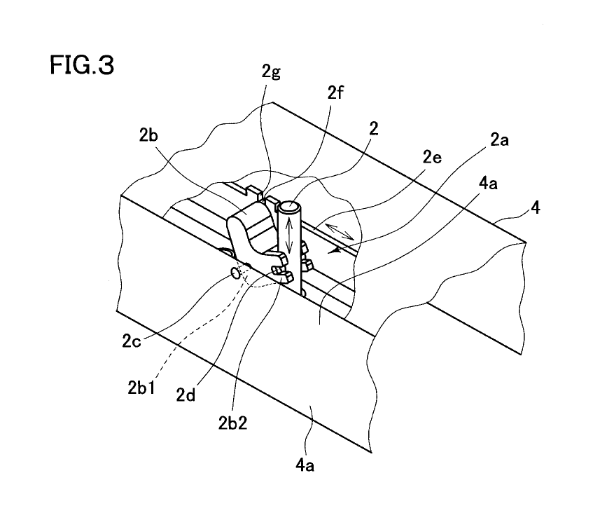

FIG. 3 illustrates an example of a driving mechanism 2a of the punching pins 2. Referring to the drawing, a link 2b formed in a substantially L-like shape and located inside the frame 4 is supported by a support pin 2c so as to rotate around the support pin 2c in an intermediate section 2b1 of the link 2b on one of the side plate portions 4a of the frame 4.

The link 2b is coupled with the punching pin 2 by a biforked arm portion 2b2 formed on one end thereof via a punching support pin 2d. Further, the link 2b is coupled so that an arm engaging pin 2f on the other end thereof protruding toward a sliding arm 2e formed separately from the frame 4 and located inside the frame 4 is engaged with an engagement groove 2g of the sliding arm 2e.

The sliding arm 2e is reciprocated by a driving source (not shown). As a result of the reciprocating movement, the link 2b is rotated around the support pin 2c, and the punching pin 2 is reciprocated in a punching direction. The number of the punching pins 2 to be provided is equal to the number of the punched holes P needed for filing (four punching pins 2 are provided in FIG. 1).

The frame 4 is provided with paper feed ports 5 for the sheet material W to be transported through. The paper feed ports 5 are formed in the side plate portions 4a on both sides of the frame 4 respectively located on upstream and downstream sides in a transport direction A of the sheet material W. The openings of the paper feed ports 5 are formed in a direction intersecting with the longitudinal direction of the frame 4. More specifically, the paper feed ports 5 are formed by forming cutouts 4b at given intervals in a thickness direction of the sheet material W and in a longitudinal direction of the side plate portions 4a on both sides of the frame 4.

The side plate portions 4a on both sides constituting the paper feed ports 5 have die support portions 5a respectively located on the upstream and downstream sides in the transport direction A of the sheet material W. The die support portions 5a are provided to support the die member 3 bridged across between the upstream and downstream sides with the die holes 3a situated therebetween. This structural feature prevents deflection of the die member 3 caused by the punching force applied to the die member 3 by the punching pins 2 during the formation of the punched holes P. According to this embodiment, opening edges 4c of the side plate portions 4a in the cutouts 4b formed as openings constitute the die support portions 5a.

The die member 3 is formed in a band plate shape from a band plate member, and the die holes 3a are formed at substantially the center of the die member 3 in a band width thereof. The die member 3 is bridged across between the cutouts 4b with one and the other sides in a band width direction thereof being caught on the opening edges 4c of the cutouts 4b.

According to the sheet material punching device 1 thus configured, when the sheet material W transported through the paper feed ports 5 is situated between the punching pins 2 and the die holes 3a (see FIG. 2), the punching pins 2 are moved downward. Then, tips of the punching pins 2 are punctured into the sheet material W to penetrate therethrough, and the punched holes P are formed in the sheet material W in the thickness direction T by the joint work of the punching pins 2 and the die holes 3a.

When the punched holes are formed, an applied load is maximized when the punching pins 2 penetrate through the sheet material W. A punching reaction force generated then is applied to the frame 4 byway of the punching pins 2 (driving mechanism 2a). However, the frame 4 has a rigidity that can avoid substantive deflection or minimize deflection, if generated, against the punching reaction force. The die support portions 5a formed on the both sides of the frame 4 support the rear surface of the die member 3 in a predefined length in the width direction of the sheet material W, for example, in a large dimension throughout the longitudinal direction. Such a support mechanism increases the strength against the punching force when the punching pins 2 are punctured through the sheet material W, thereby reducing any energy loss caused by the deflection. Further, the device per se is unlikely to be upsized or increased in weight because the frame 4 and the die member 3 are plate-like members simply structured. As a result, the device can be inexpensively produced.

The die member 3 is provided with a sheet material transport guide 3c protruding on the upstream side in the transport direction A of the die member 3 to stay in contact with a transport destination edge side W1 of the transported sheet material W to thereby slidably guide the sheet material W through the paper feed ports 5. The sheet material transport guide 3c protrudes continuously from a section joined with the opening edges 4c of the cutouts 4b on the both sides in the band width direction of the die member 3.

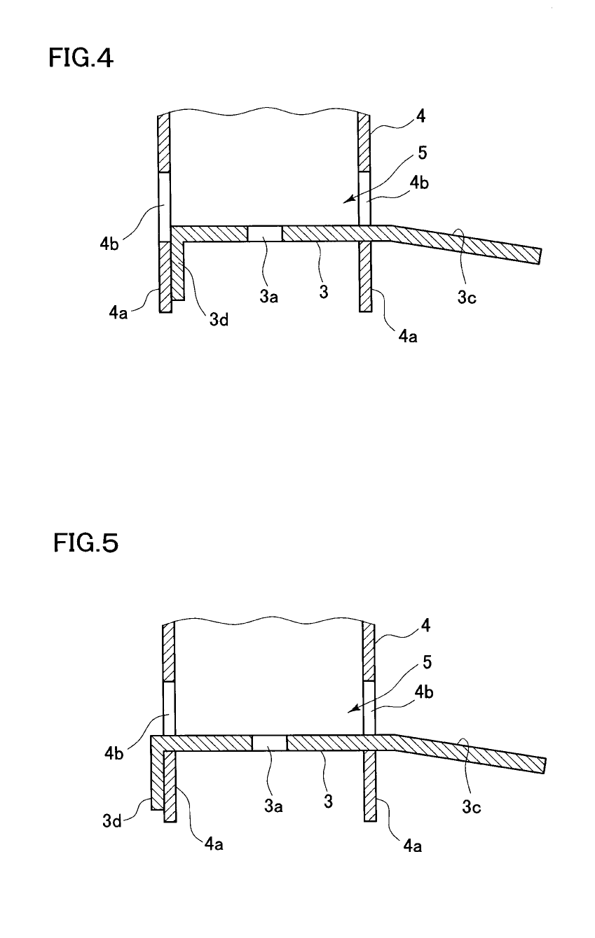

FIG. 4 illustrates a modified embodiment of the sheet material punching device 1. In this embodiment, the die member 3 has a protruding plate portion 3d formed so as to protrude in its own plate thickness direction, wherein the protruding plate portion 3d is joined with an inner surface of the side plate portion 4a on the other end of the frame 4 (downstream side in the transport direction) by planar contact. The protruding plate portion 3d may be partly joined with the inner surface by spot welding or with an adhesive, or may be wholly joined.

FIG. 5 illustrates another modified embodiment, wherein the protruding plate portion 3d is joined with an outer surface of the side plate portion 4a on the other end of the frame 4 (downstream side in the transport direction).

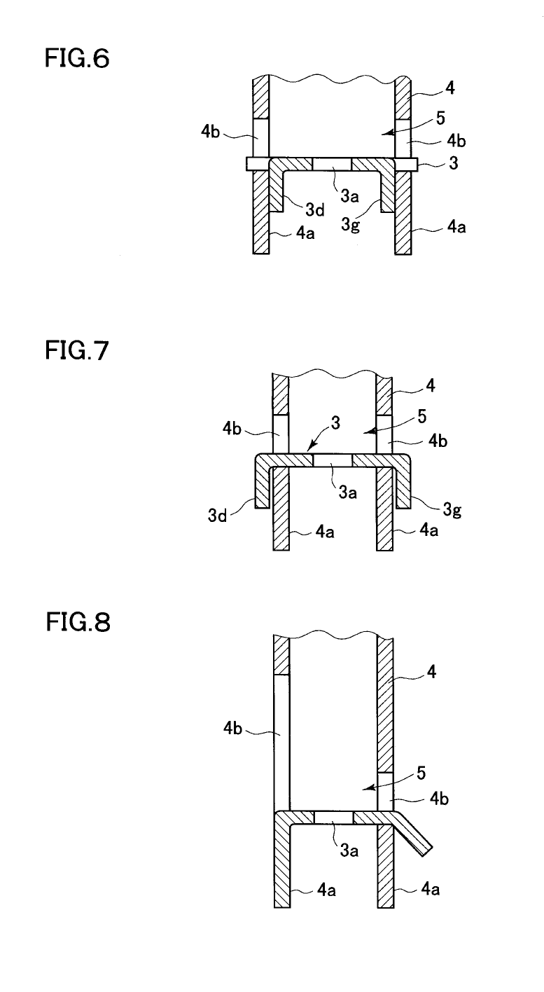

FIG. 6 illustrates still another modified embodiment, wherein a protruding plate portion 3d similar to that of FIG. 4 is formed in an end portion of the die member 3 on the sheet-transport downstream side, and a protruding plate portion 3g is formed on the upstream side of the die member 3 as well. The protruding plate portion 3d is joined with the inner surface of the side plate portion 4a on the downstream side (inner surface of the frame 4) by planer contact. Similarly, the protruding plate portion 3g is joined with an inner surface of the side plate portion 4a on the upstream side by planer contact.

In the example illustrated in FIG. 6, the protruding plate portions 3d and 3g may be formed only in a region where the die holes 3a are formed in the longitudinal direction of the die member 3 (direction orthogonal to the sheet transport direction), whereas any other region (both end portions of the die member 3 in the longitudinal direction) has no protruding plate portion 3d or 3g. As illustrated in FIG. 6, the parts of the die member 3 with no protruding plate portion 3d or 3g are extended straight laterally in the drawing to be caught on the side plate portions 4a and 4a on the upstream and downstream sides.

On the contrary, the region where the die holes 3a are formed in the longitudinal direction of the die member 3 may be extended straight laterally in the drawing to be caught on the side plate portions 4a and 4a on the upstream and downstream sides, while any other region (both end portions of the die member 3 in the longitudinal direction) may be provided with the protruding plate portions 3d and 3g.

Though the sheet material transport guide 3c illustrated in FIG. 4 is not formed in the example of FIG. 6, a part of the die member 3 on the upstream side where the protruding plate portion 3g is not formed may be extended on the upstream side as illustrated in FIG. 4 and used as the sheet material transport guide 3c.

FIG. 7 illustrates still another modified embodiment. According to the modified embodiment, a protruding plate portion 3d similar to that of FIG. 5 is formed in the end portion of the die member 3 on the downstream side, and a protruding plate portion 3g is formed in the end portion of the die member 3 on the upstream side. The protruding plate portions 3d and 3g may be respectively joined or may not be joined with outer surfaces of the side plate portions 4a and 4a on the downstream and upstream sides (outer surface of the frame 4) by planer contact.

As illustrated in the drawings, parts of the die member 3 near the protruding plate portions 3d and 3g are abutted to the opening edges (die support portion) of the openings 4b and 4b formed in the side plate portions 4a and 4a, and the die member 3 is bridged across between the openings 4b and 4b of the side plate portions 4a and 4a.

FIG. 8 illustrates still another modified embodiment. According to the modified embodiment, the side plate portion 4a on the downstream side of the frame 4 is bent to form a sheet transport surface. More specifically, a longitudinal length of the opening 4b is increased in the side plate portion 4a on the downstream side of the frame 4, and the side plate portion 4b in the opening 4b is bent 90 degrees toward the upstream side at a lower end of the opening 4b left uncut. The side plate portion 4b is then caught on the opening edge of the side plate portion 4a on the upstream side.

An upstream end portion of the side plate portion 4a on the downstream side thus bent and located is preferably extended farther to the upstream side than the side plate portion 4a on the upstream side. As illustrated in FIG. 8, the side plate portion 4a thus caught on the opening edge has the die holes 3a. According to the example illustrated in FIG. 8, as the number of necessary components can be decreased and it is unnecessary to join the frame 4 and the die member 3 with each other, the device can be produced and processed at low cost.

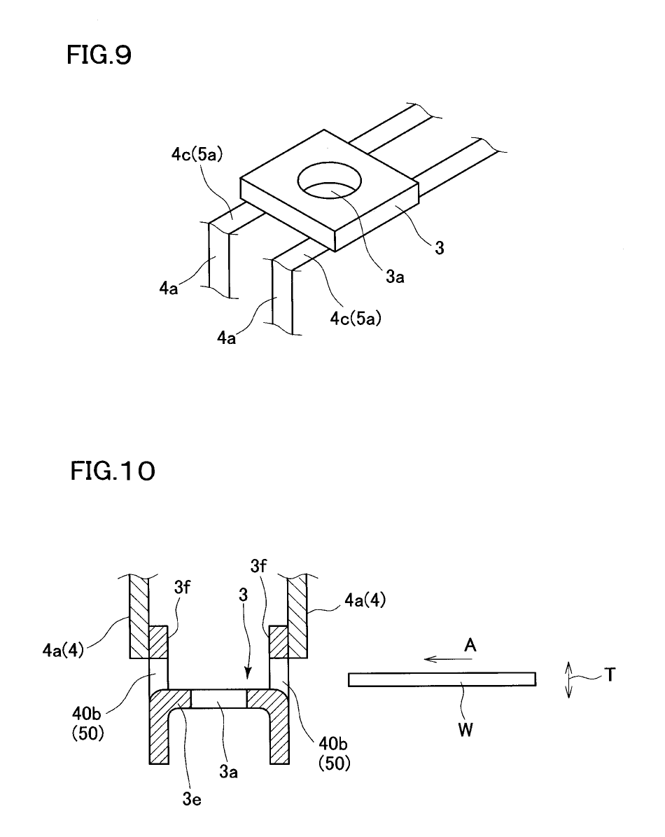

FIG. 9 is a modified embodiment of the die member 3, wherein a plurality of die members 3 each having one die hole 3a are provided to be respectively paired with the punching pins 2 plurally formed.

FIG. 10 illustrates still another modified embodiment of the sheet material punching device 1. Any other structural elements of the device in this embodiment are similar to those according to the above-described embodiments. Below are described specific differences to the structural elements in the other examples.

In this embodiment, a plate member having an H-like shape in cross section and formed integrally in a longitudinal shape constitutes the die member 3. The die member 3 has die holes 3a formed in a center plate portion 3e on which the sheet material W is placed. In the die member 3, paper feed ports 50 for the sheet material W to be transported through are provided by forming cutouts 40b at given intervals in the thickness direction of the sheet material W and in the direction intersecting with the longitudinal direction of the frame 4.

Both-side plate portions 3f are formed on both sides of the center plate portion 3e. The both-side plate portions 3f are joined with the side plate portions 4a of the frame 4 by planar contact so that the die member 3 and the frame 4 are integral with each other. Such a structural characteristic can prevent deflection of the die member 3 caused by the punching force applied to the die member 3 by the punching pins 2 during the formation of the punched holes.

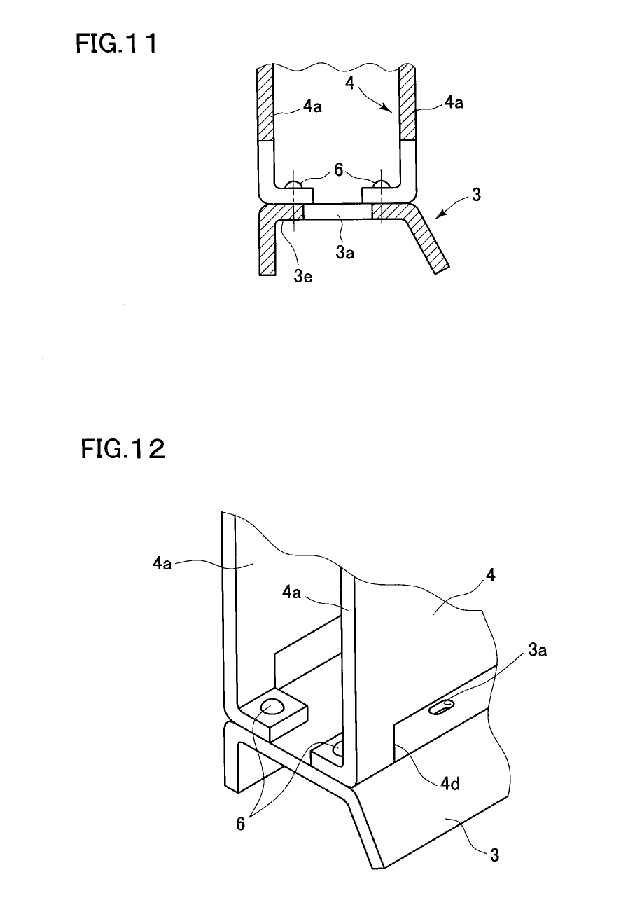

FIG. 11 is a cross-sectional view of the modified embodiment of FIG. 10. FIG. 12 is a perspective view of the illustration of FIG. 11. In this embodiment, a method of planar contact illustrated in FIG. 10 is changed. More specifically, the frame 4 is provided with a space for the sheet material W to be transported through and brought into planar contact with the die member 3, and the die member 3 and the frame 4 are integrally put together by means of rivets 5 (or bolts). Due to such a configuration, it is possible to prevent deflection of the die member 3 caused by the punching force applied to the die member 3 by the punching pins 2 during the formation of the punched holes.

Descriptions have been given of the embodiments of the invention. However, these embodiments are merely exemplary, and the invention is not limited thereto. The technical matters recited in the respective embodiments may be used in other embodiments or may be differently combined into different embodiments.

What is claimed is:

1. A sheet material punching device, comprising:
a punching pin driven so as to reciprocate on a sheet material being transported;
a die member having die holes to form punched holes jointly with the punching pin in the sheet material placed thereon in a thickness direction of the sheet material;
a frame having wall portions respectively provided on an upstream side and a downstream side in a transport direction of the sheet material, the die member and the punching pin being provided in a space between the wall portion on the upstream side and the wall portion on the downstream side, the frame further having a longitudinal direction extending in a width direction of the sheet material; and
paper feed ports respectively formed in the wall portions on the upstream and downstream sides, the paper feed ports being provided for the sheet material to be transported through, wherein
the die member being bridged across between the paper feed ports on the both sides is supported in a predefined length in the width direction of the sheet material.

2. The sheet material punching device as claimed in claim 1, wherein
the wall portions of the frame having the paper feed ports on the both sides thereof are side plate portions formed in a plate shape, and the side plate portions on the both sides have cutouts formed at given intervals in the thickness direction of the sheet material serving as the paper feed ports, and
the die member is formed from a band plate member and the die member is bridged across between the cutouts with one and the other sides in a band width direction thereof being caught on the cutouts.

3. The sheet material punching device as claimed in claim 2, wherein
the die member has a sheet material transport guide protruding on the upstream side in the transport direction to stay in contact with a transport destination edge side of the transported sheet material to thereby slidably guide the sheet material through the paper feed ports.

4. The sheet material punching device as claimed in claim 2, wherein
the die member has a protruding plate portion protruding in a plate thickness direction thereof, and the protruding plate portion is joined with the side plate portions of the frame.

5. The sheet material punching device as claimed in claim 1, wherein
a plurality of the punching pins are provided, and a plurality of die members each having a die hole are provided to be respectively paired with the punching pins.

6. A sheet material punching device, comprising:
a punching pin driven so as to reciprocate on a sheet material being transported;
a die member having die holes to form punched holes jointly with the punching pin in the sheet material placed thereon in a thickness direction of the sheet material;
a frame having wall portions respectively provided on an upstream side and a downstream side in a transport direction of the sheet material, the die member and the punching pin being provided in a space between the wall portion on the upstream side and the wall portion on the downstream side, the frame further having a longitudinal direction extending in a width direction of the sheet material; and
paper feed ports respectively formed in side plate portions on both sides of a center plate portion of the die member formed in an H-like shape in cross section and having the die holes in the center plate portion thereof, the paper feed ports being provided for the sheet material to be transported through and placed on the center plate portion, wherein
the side plate portions on the both sides of the die member are joined with the wall portions of the frame in order for the die member and the frame to be integral with each other.
